(19) United States
(12) Patent Application Publication
(10) Pub. No.: US 2006/0061030 A1
(43) Pub. Date: Mar. 23, 2006

(54) Sheet trimming apparatus, sheet post-processing apparatus and image forming system

(76) Inventors: Masahiro Kaneko, Tokyo (JP); Toshio Shida, Tokyo (JP); Hiroyuki Wakabayashi, Tokyo (JP)

Correspondence Address: CANTOR COLBURN, LLP, 55 GRIFFIN ROAD SOUTH, BLOOMFIELD, CT, 06002, US

(21) Appl. No.: 11/113,863

(22) Filed: Apr. 25, 2005

(30) Foreign Application Priority Data
Sep. 22, 2004 (JP) JP2004-274735

(51) Int. Cl. B42B 2/00

(52) U.S. Cl. 270/52.17

(57) ABSTRACT

A sheet trimming apparatus comprising a trimming blade to trim a bundle of sheets, a blade receiving member to receive the trimming blade and a sheet supporting member located in a position facing the blade receiving member to hold the bundle of sheets when the bundle of sheets is trimmed with the trimming blade, at least one of the blade receiving member and the sheet supporting member has an electrically conductive surface which comes into contact with a bundle of sheets.

This application is based on Japanese Patent Application No. 2004-274735 filed on Sep. 22, 2004 in Japanese Patent Office, the entire content of which is hereby incorporated by reference.

### BACKGROUND OF THE INVENTION

The present invention is related to a sheet trimming apparatus to trim a plurality of sheets, a sheet post-processing apparatus having the sheet trimming apparatus, and an image forming system employing the sheet trimming apparatus.

A versatile image forming system has been widely employed in which a high speed image forming apparatus such as an image forming apparatus of an electronics photographing system, is connected to a sheet post-processing apparatus to be able to carry out, on image-formed sheets in a single apparatus, various kinds of post-process such as a perforating process, a stitching process and a folding process.

Some of these sheet post-processing apparatuses are equipped with sheet trimming apparatuses which trim the edge of a bundle of plural sheets after a perforating process, a stitching process and a folding process, and the following kinds of sheet trimming apparatuses are well known.

Specifically, a trimming apparatus to cut a plurality of sheets piled on a table with a cutter rising obliquely while holding the sheets with a sheet holder, which is lowered along vertical guide plates. Each sheet holder and cutter has a motor, the rotation of which is transmitted to a screw engaged with a nut which is connected with links of the sheet holder or links of the cutter so that they can be driven by even small motors (for example, refer to Patent Document 1).

[Patent Document 1] Japanese Non-examined Patent Publication No. 2003-136471

According to the structure described in Patent Document 1, it is possible to use an apparatus of this structure as a supplemental apparatus for an office machine to be used in an office of limited space because its small size results from drive of a small motor. However it may happen that strips from trimmed sheets cling to the table or the sheet holder without falling down because of static electricity generated during each process such as a perforating process, a stitching process or a folding process, or generated from rubbing of sheets on the table or the sheet holder during insertion of the sheets into the trimming section or generated during trimming.

If trimming is conducted while the strips are clinging to the table or the sheet holder, the quality of the product deteriorates because the marks of the strips are transferred onto a sheet of the bundle of sheets due to strong pressing force on the sheets. Further, a skew or a fold of outer sheets of the subsequent bundle of sheets may be caused by these clinging strips while the subsequent bundle of the sheet is inserted into the trimming section. In the case of a sheet trimming apparatus in which the upper and the lower blades pinch and trim a bundle of sheets, generally the two blades are made of steel, an electrically conductive material, and static electricity of the bundle of sheets is eliminated during the trimming process resulting in avoiding electrostatic adsorption of trimmed strips to other members with static electricity. However in the case of a sheet trimming apparatus structured so that the apparatus has a blade on only either side, and conducts press cutting of a bundle of sheets as described in Patent Document 1, the afore-said problems occur. The present invention is created from the view of the problems described above and the objective is to provide a sheet trimming apparatus which can perform stable trimming during the trimming process without any adverse influence on quality of the finished bundle of sheets.

### SUMMARY OF THE INVENTION

An objective of this invention can be achieved by the following structures.

(A) A sheet trimming apparatus to trim a bundle of sheets, comprising:

a trimming blade to trim a bundle of sheets,

a blade receiving member located in a position facing the trimming blade to receive the trimming blade and

a sheet supporting member to hold a bundle of sheets when the bundle of sheets is trimmed with the trimming blade,

wherein at least one of the blade receiving member and the sheet supporting member has an electrically conductive surface which comes into contact with a bundle of sheets.

(B) A sheet post-processing apparatus comprising a sheet trimming apparatus to trim a bundle of sheets,

wherein the sheet trimming apparatus comprises,

a trimming blade to trim a bundle of sheets,

a blade receiving member located in a position facing the trimming blade to receive the trimming blade and

a sheet supporting member to hold a bundle of sheets when the bundle of sheets is trimmed with the trimming blade,

wherein at least one of the blade receiving member and the sheet supporting member has an electrically conductive surface which comes into contact with a bundle of sheets.

(C) An image forming system, comprising:

an image forming apparatus to form an image on a sheet and

a sheet post-processing apparatus to apply post-processing to the sheet on which the image is formed by the image forming apparatus,

wherein the sheet post-processing apparatus includes a sheet trimming apparatus, comprising:

a trimming blade to trim a bundle of sheets,

a blade receiving member located in a position facing the trimming blade to receive the trimming blade and

a sheet supporting member to hold a bundle of sheets when the bundle of sheets is trimmed with the trimming blade,

wherein at least one of the blade receiving member and the sheet supporting member has an electrically conductive surface which comes into contact with a bundle of sheets.

### BRIEF DESCRIPTION OF THE DRAWING

FIG. 1 is an overall structural view of an image forming apparatus equipped with a sheet post-processing apparatus.

FIG. 2 is a schematic frontal view of the sheet post-processing apparatus.

FIG. 3 is the right side view of the sheet post-processing apparatus in FIG. 2.

FIG. 4 is the left side view of the sheet post-processing apparatus in FIG. 2.

FIG. 5 is a schematic diagram showing a part of sheet flow in the sheet post-processing apparatus.

FIG. 6(a) and 6(b) are schematic diagrams of the trimming conveyer 600 and the conveying mechanism for the bundle of sheet SS.

FIG. 7 is a schematic frontal view of the sheet trimming apparatus 700 viewed from the sheet insertion direction.

FIG. 8 is a cross section of main parts viewed from line U-U in FIG. 7.

### DETAILED DESCRIPTION OF THE PREFERRED EMBODIMENT

An example of this embodiment of a sheet trimming apparatus related to this invention will be explained below, referring to drawings.

The sheet trimming apparatus of this embodiment is composed as part of a sheet post-processing apparatus, which is connected to an image forming apparatus which structures an image forming system.

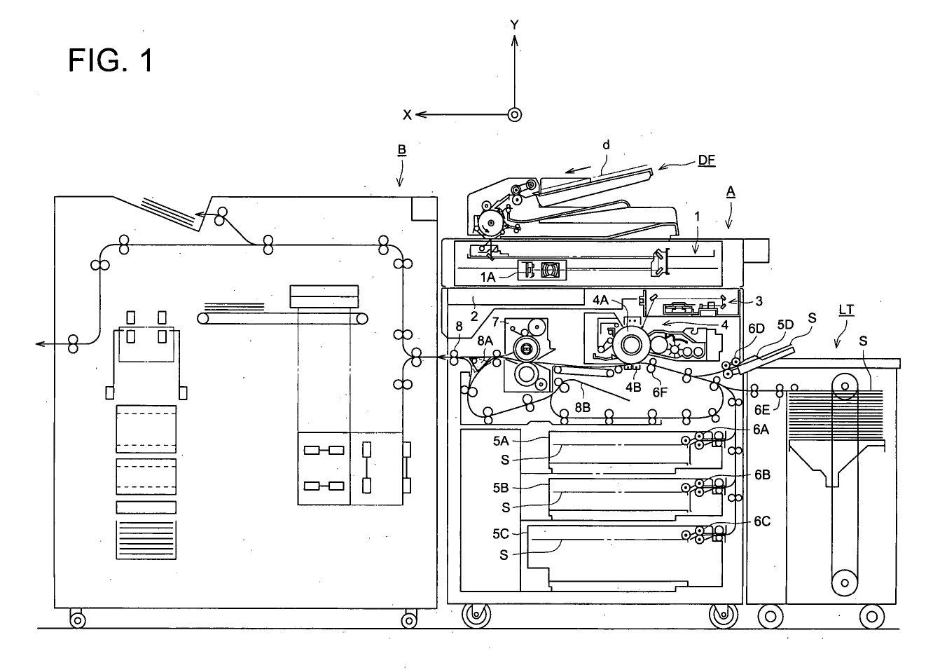

FIG. 1 is a general structural view of an image forming system including an image forming apparatus and a sheet post-processing apparatus.

The symbol A indicates an image forming apparatus, DF indicates an automatic document feeder, LT indicates a large-capacity paper feeder and B indicates a post-processing apparatus.

The image-forming apparatus A includes an image-reading portion (image input device) 1, an image-processing portion 2, an image-writing portion 3, an image-forming portion 4, paper-feed cassettes 5A, 5B, 5C, a manual paper-feed tray 5D, first paper feeders 6A, 6B, 6C, 6D, 6E, a registration roller 6F, a fixing unit 7, a paper discharge portion 8 and an automatic duplex copy paper feeder (ADU) 8B.

The automatic document feeder DF is mounted on the upper part of the image-forming apparatus A and the sheet post-processing apparatus B is connected to the image-forming apparatus solidly as shown in the left side of the diagram.

An original document d set on a document tray of the automatic document feeder DF is conveyed in the direction of the arrow and an image on one side or images on both sides of the document is read by a CCD image sensor 1A of an optical system in the image-reading portion 1.

Analog signals which have been photoelectrically transduced by the CCD image sensor 1A are, analog-processed, A/D converted, processed with shading correction and image-compressed in the image-processing portion 2 and then sent to the image-writing portion 3 as image information signals.

The image-forming portion 4 is a portion forming images with electrophotographic process, where processes such as charging, exposure, development, transfer, separation and cleaning are carried out on a photoreceptor drum 4A. A ray of light from a semiconductor laser (not illustrated) based on the image information signal is irradiated to the photoreceptor drum 4A and an electrostatic latent image is formed in the process of exposure. Further, a toner image corresponding to the electrostatic latent image is formed on the photoreceptor drum 4A in the process of development.

When one of the feeders among the paper-feed cassettes from 5A through 5C, the manual paper-feed tray 5D and the large-capacity paper feeder LT is selected together with the corresponding first paper feeder among 6A through 6E, a sheet of paper S is conveyed toward the registration roller 6F. The sheet of paper is synchronized with a toner image on the photoreceptor drum 4A by the registration roller 6F to be conveyed toward a transfer means 4B so that the toner image is transferred on it.

A sheet of paper S carrying a toner image is fed from the paper discharge portion 8 to the sheet post-processing apparatus B after the toner image is fixed by the fixing unit 7.

When the automatic duplex copy is selected, a sheet of paper of which an image is formed on one side is fed to the automatic duplex copy paper feeder 8B by switching of a conveying passage switching plate 8A, so that another image forming is carried out on the other side of the sheet in the image-forming portion 4, and fed to the sheet post-processing apparatus B from the paper discharge portion 8 after the toner image is fixed by the fixing unit 7.

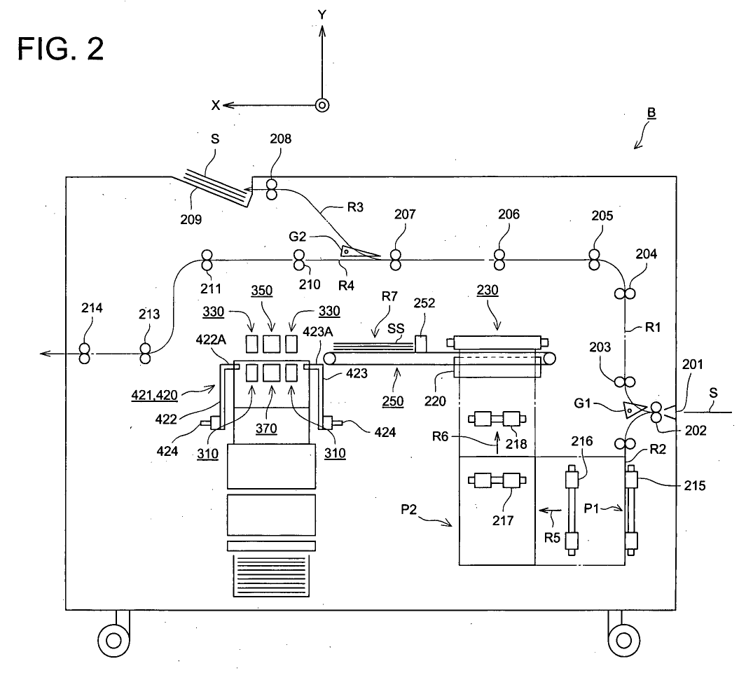

Next, an explanation will be given regarding the outline of the sheet post-processing apparatus B referring to FIGS. 2, 3, 4 and 5.

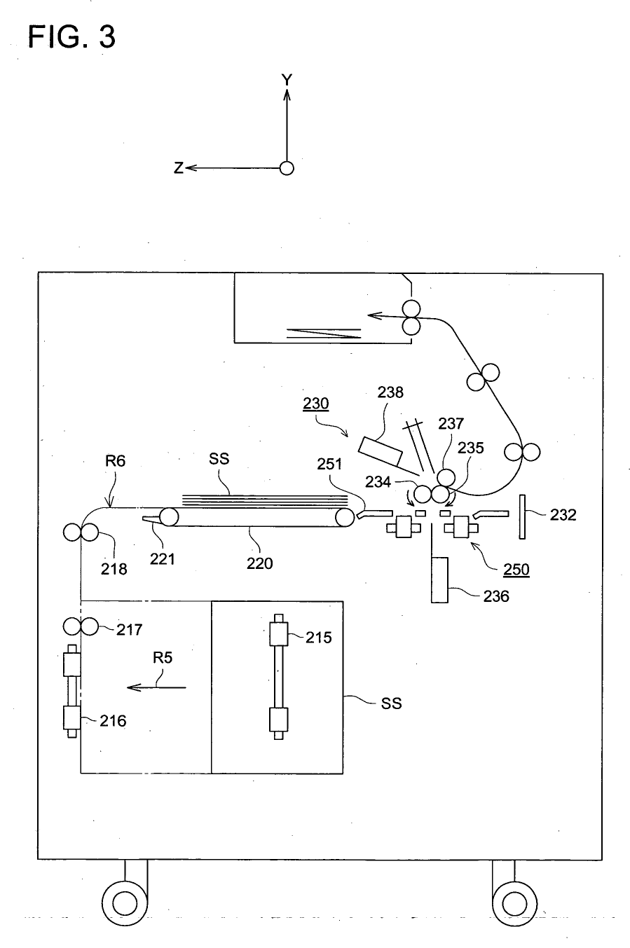

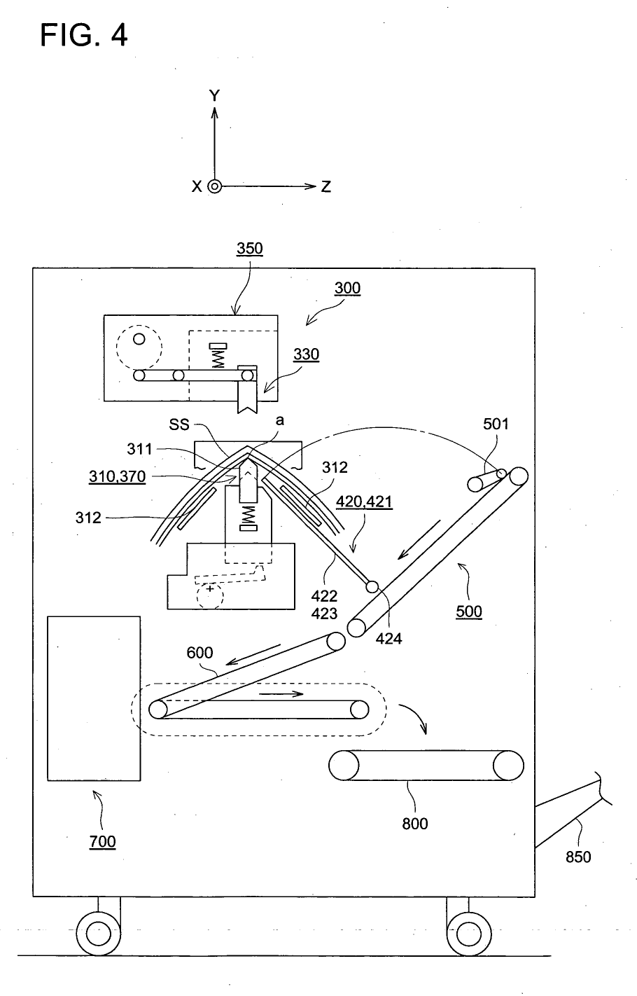

FIG. 2 is a front view of a sheet post-processing apparatus related to this embodiment, FIG. 3 is a right side view of it, FIG. 4 is a left side view of it and FIG. 5 is a schematic diagram showing a part of a sheet flow in the sheet post-processing apparatus.

In each of the above-mentioned views, arrows X, Y and Z represent axes of rectangular coordinates indicating directions, and positive directions of coordinates are named X direction, Y direction and Z direction and negative directions are named reverse X direction, reverse Y direction and reverse Z direction respectively.

Regarding the directions perpendicular to the sheet of paper, when the arrow points toward the surface of the sheet, it is described by ⊚, and when the arrow points toward the back of the sheet, it is described by ◯.

The sheet of paper S on which an image is formed by the image-forming apparatus is conveyed to either a conveying passage through which the sheet is delivered without being processed or a conveying passage in which center-folding and saddle-stitching are processed on the sheet via a convey passage switching means at the entrance of the sheet post-processing apparatus B.

The sheets S fed to the conveying passage for center-folding and saddle-stitching are subjected to center-folding after plural sheets are piled, and then loaded on an inverted V-shaped loading means. After the number of the sheets piled reaches the prescribed one, saddle-stitching is conducted and then the sheets are unloaded by an unloading means and discharged after trimming of the edge of the bundle of the sheet by the sheet trimming apparatus related to the invention.

Firstly, an explanation will be given regarding a conveying route of the sheet S which has entered a conveying passage R1 referring to FIG. 2.

The sheet S fed to the conveying passage R1 by a passage-switching means G1 is pinched and conveyed by conveying rollers 203 through 207 to be fed to either a conveying passage R3 on the upper side of a conveying-passage switching means G2 or a conveying passage R4 on the lower side thereof.

The sheet S fed to the upper conveying passage R3 is delivered by a paper-discharge roller 208 to a sub-discharge tray (top tray) 209 located on the upper portion of the sheet post-processing apparatus B.

The sheet S fed to the lower conveying passage R4 is pinched and conveyed by conveying rollers 210 through 213 and fed to another sheet post-processing apparatus and so on by a paper-discharge roller 214.

Next, an explanation will be given regarding conveyance of the sheet S which has entered a conveying passage R2, referring to FIG. 2 and FIG. 5.

The sheet S fed to the conveying passage R2 by the conveying-passage switching means G1 is conveyed in the reverse Y direction and stays to be stored temporarily at the prescribed position (position P1 indicated in the diagram).

A small amount of subsequent sheets S are piled additionally to be stored at the position P1.

Although the number of stored sheets stated above according to the embodiment is three, the number is not limited to this and can be set properly.

The stored three sheets S at the position P1 are conveyed in the piled state in the Z direction by conveying rollers 215 and guide plates (not illustrated), and then are turned to be deviated in the X direction by conveying rollers 216 and guide plates (not illustrated), and stop temporarily at the position P2 (conveying passage R5).

In the following explanation, plural sheets S piled are simply represented by a bundle of sheets SS, unless otherwise provided.

The bundle of sheets SS staying at the position P2 temporarily is conveyed in the Y direction according to a prescribed timing by conveying rollers 217, 218 and guide plates, and then is deviated in the reverse Z direction (conveying passage R6).

The bundle of sheets SS deviated in the reverse Z direction is fed to a center-folding means 230 by a conveyance-aligning belt 220.

Here, an explanation is given regarding the center-folding means 230 referring to FIG. 3.

The means according to the embodiment is structured so that the lengthwise direction of the bundle of sheets SS may agree with the direction of conveyance of the conveyance-aligning belt 220.

The center-folding means 230 includes an aligning member 232, center-folding rollers 234, 235 and a center-folding knife 236.

The aligning plate 232 is located so that the distance between the aligning plate and the contacting point of center-folding rollers 234 and 235 is equivalent to a half length of the sheet S in the lengthwise direction of the sheet.

The bundle of sheets SS conveyed in the reverse Z direction is pushed by an aligning claw 221 mounted on the conveyance-aligning belt 220 and conveyed on a guide plate 251 which composes a center-fold sheet conveying means 250, which will be described later, until the bundle of sheets SS stops at the position where the leading edge of the bundle of sheets SS hits the aligning member 232.

Subsequently, the aligning claw 221 is moved back and forth by a reciprocal rotation of the conveyance-aligning belt 220, and the trailing edges of the bundle of sheets SS (three sheets) are pressed and the bundle of sheets SS is aligned in terms of width in the direction of the conveyance.

After completion of the aligning operation described above, the center-folding knife 236 mounted at the lower position of the contacting point of the center-folding rollers 234 and 235 pushes up the bundle of sheets SS on the guide plate 251 at the middle portion in the lengthwise direction of the bundle of sheets SS to make the sheets to be pinched by the center-folding rollers 234 and 235 rotating in the directions of arrows shown in the diagram.

After the pinched bundle of sheets SS is given a fold at the middle portion in the lengthwise direction of the sheets by the center-folding rollers 234 and 235, the sheets are fed back onto the guide plate 251 by reverse rotation of the center-folding rollers 234 and 235 and transported in the direction of X by the center-fold sheet conveying means 250 which will be described later.

The means is composed wherein, when the size of the sheet is changed, the position of the aligning plate 232 and the operation of the aligning belt 220 and so on can be changed according to the size of the sheet by a control means which is not illustrated.

It is also possible to apply Z shaped folding (tri-folding) to the bundle of sheets SS by using a roller 237 and a folding knife 238.

Back to FIGS. 2 and 5, the bundle of sheets SS given a fold at the middle portion in the lengthwise direction of the sheets is conveyed in the X direction by a conveying claw 252 fixed on the conveying belt of the center-fold sheet conveying means 250 and guide plates which are not illustrated, and loaded on a loading means 310 (conveying passage R7).

Next, an explanation will be given regarding the loading means 310, a stapling means 350 and a staple receiving means 370 which constitute a saddle-stitching means, referring to FIG. 4.

The loading means 310 includes a fold-supporting member 311 which is inverted V-shaped and side edge supporting members 312 which are also inverted V-shaped, and the fold-supporting member 311 supports the vicinity of fold “a” on the valley side (lower side) of the bundle of creased sheets SS and the side edge supporting members 312 supports the valley side of side edge portions of the bundle of creased sheets SS.

The valley side surface of the bundle of creased sheets SS represents the inner surfaces facing each other when the sheets are folded along the fold and a hill side surface represents the outer surfaces of the sheets.

A holding means 330 which is vertically movable and the stapling means 350 which is fixed to the body are placed above the loading means 310.

The staple receiving means 370 which is vertically movable is placed below the fold “a” of the loaded bundle of sheets SS.

A pair of the stapling means 350 and a pair of the staple receiving means 370 both of which are parts of sheet-stitching means are placed at two positions equally divided on both sides when viewed in the lengthwise direction of the fold.

By means of the structure described above, when the number of the bundle of sheets SS loaded on the loading means 310 reaches the prescribed one, the holding means 330 lowers and the staple receiving means 370 rises while the holding means 330 is holding the bundle of sheets SS and then staples are shot to two portions on the fold of the bundle of sheets SS by the stapling means 350.

An explanation will be given regarding how to unload the saddle-stitched bundle of sheets SS referring to FIG. 2 and FIG. 4.

An unloading means 420 for unloading the bundle of sheets SS includes a supporting means 421 and a driving means (no reference symbol).

The supporting means 421 includes supporting members 422 and 423 which are located on the both ends of the bundle of sheets SS loaded on the loading means 310 and the supporting members 422 and 423 are structured by bar members having bent parts 422A and 423A respectively where they are bent at a right angle at the ends to support a fold part of the bundle of sheets SS.

The other ends of the supporting members 422 and 423 are supported rotatably around a supporting axis 424.

The supporting members 422 and 423 are structured on right and left in FIG. 2 so that they can be inserted in and parted from the fold part of the bundle of sheets SS in order to support the loaded bundle of sheets SS by the driving means.

The supporting members 422 and 423 are swung by the driving means with the supporting axis 424 centered, between an unloading position for the bundle of sheets SS placed on the loading means 310 and a delivering position for the bundle of sheets SS to be delivered to a receiving conveyor 500 as shown in FIG. 4.

By means of this structure, when the number of the bundle of sheets SS loaded on the loading means 310 reaches the prescribed one and the saddle-stitching process is completed by the saddle-stitching means, the supporting means 422 and 423 are inserted in space near the fold of the loaded sheets, and support the bundle of sheets SS at the fold part, and then, swing from the unloading position to the delivering position so that the bundle of sheets SS is loaded on the receiving conveyor 500 and the loaded bundle of sheets SS is pinched by a grip 501.

The bundle of sheets SS pinched by the grip 501 is conveyed downward obliquely, according to the rotation of the receiving conveyor 500 and delivered to a trimming conveyor 600 after released from the grip 501.

The trimming conveyor 600 is leveled down after the delivery of the bundle of sheets SS, and subsequently, the bundle of sheets SS is conveyed toward a sheet trimming device 700 with the fold part being held by a fold-holding member which will be described later and uneven edges (free edge on the opposite side of a fold) are trimmed by the sheet trimming device 700, after the sheets are stopped at the prescribed position.

After the trimming process is completed, the bundle of sheets SS is conveyed in the reverse direction by the trimming conveyor 600 and dropped from the end of the trimming conveyor 600 in the direction of the arrow to be collected by a collecting conveyor 800 and to be discharged to a paper discharge tray 850 located on the outside of the front face of the sheet post-processing apparatus B.

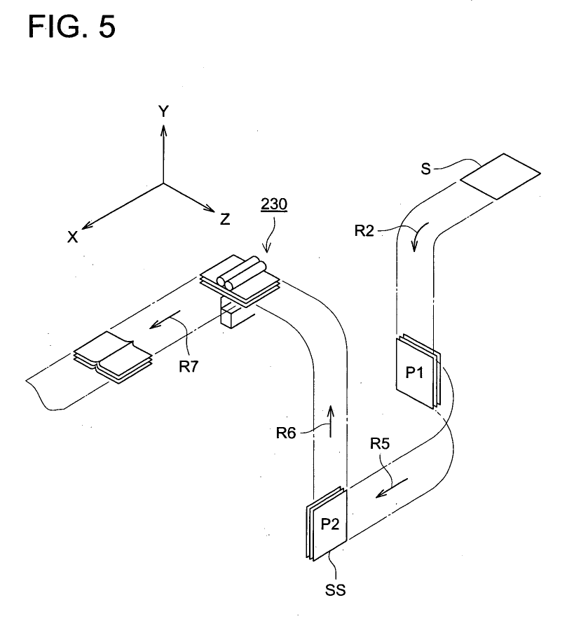

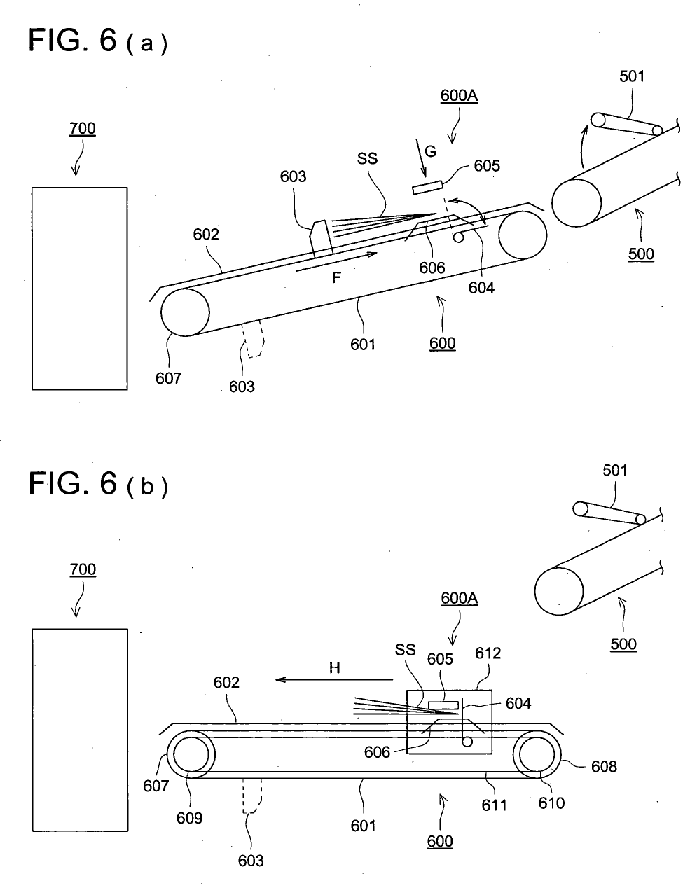

Next, a detailed explanation will be given regarding the sheet trimming apparatus 700, referring to FIGS. 6 through 8.

FIG. 6 shows a schematic diagram of the trimming conveyor 600 and a conveying mechanism for the bundle of sheets SS.

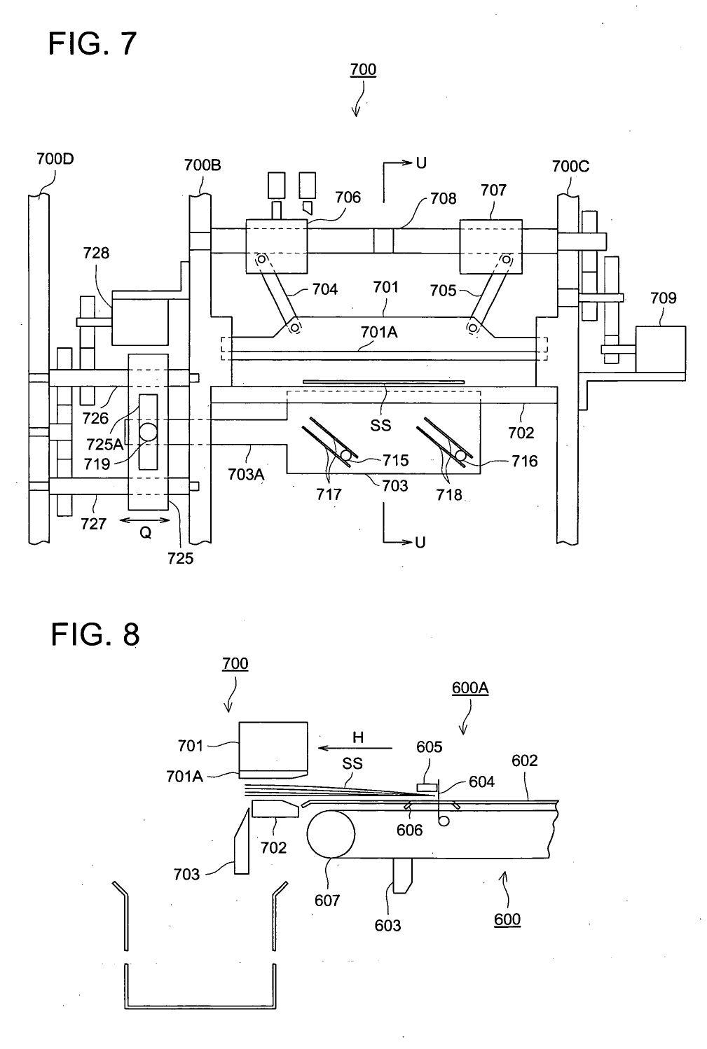

FIG. 7 is a schematic frontal view of the sheet trimming apparatus 700 viewed in the insertion direction of sheets and FIG. 8 is a cross sectional view of main parts taken on the U-U section in FIG. 7.

Firstly, an explanation will be given referring to FIG. 6 regarding a mechanism, wherein the center-folded and saddle-stitched bundle of sheets SS is delivered from the receiving conveyor 500 to the trimming conveyor 600 and stopped at a prescribed position after the delivery, for an edge trimming by the sheet trimming apparatus 700.

The Grip 501 opens and releases the bundle of sheets SS which was pinched by the grip, near the end of downstream side of the receiving conveyor 500 in the sheet conveying direction, as shown in FIG. 6(a).

The released bundle of sheets SS slides on a slant surface of a sheet loading table 602 provided to be close to and parallel to the upper part of a conveying belt 601 stretched between pulleys 607 and 608, and stops after hitting a stopper claw 603 fixed on the conveying belt 601.

An aligning member 604 swings from the position illustrated with a solid line to the position illustrated with a dotted line in the diagram after the bundle of sheets SS stops.

After the aligning member 604 swings, the conveying belt 601 moves in the direction indicated by arrow F and stops when the stopper claw 603 makes the fold part of the bundle of sheets SS hit the aligning member 604.

In this way, a skew of the bundle of sheets SS from the feeding direction is corrected by making the sheets hit the aligning member 604.

After the stopper claw 603 stops, a fold-holding member 605 lowers in the direction shown by arrow G in the diagram and pinches the bundle of sheets SS with a backing plate 606 which is mounted to have a plane which is substantially the same as the sheet loading table 602.

After completion of the pinching of the bundle of sheets SS, the trimming conveyor 600 rotates and the stopper claw 603 is retreated to the position illustrated with dotted lines in the diagram.

After completion of the retreat of the stopper claw 603, the aligning member 604, the fold-holding member 605 and the backing plate 606 are swung solidly with the trimming conveyor 600, while pinching the bundle of sheets SS, around the center of a pulley 607 of the trimming conveyor 600, and stopped at the horizontal position indicated in FIG. 6(b).

After the swing motion of the trimming conveyor 600 is completed, the bundle of sheets SS is moved in the direction of arrow H shown in the diagram while sliding on the sheet loading table 602 by an inserting means 600A, during being pinched by the fold-holding member 605 and the backing plate 606, and the bundle of sheets SS is inserted into the trimming section of the sheet trimming apparatus 700 and stops at a prescribed position determined according to the size of respective sheets.

The inserting means 600A is comprising an insertion belt 611 stretched between pulleys 609 and 610, which share the same axes with the pulleys 607 and 608 respectively, an aligning member 604 fixed on the insertion belt 611, traveling body 612 which sustains fold-holding member 605 and backing plate 606, and an insertion motor which drives the insertion belt 611 back and forth (not illustrated), and swings around the axis of the pulley 607 along with the trimming conveyer 600.

The bundle of sheets SS placed at the prescribed position by the inserting means 600A is edge-trimmed by the sheet trimming device 700. The details of the sheet trimming device 700 will now be explained, referring to FIGS. 7 and 8.

Numeral 701 represents a sheet holding member which moves vertically, numeral 701A represents a blade receiving I member provided integrally on a surface of sheet holding member 701 facing the bundle of sheets SS, numeral 702 represents a sheet supporting member fixed to main body side boards 700B and 700C, and numeral 703 represents a trimming blade (lower blade) which is vertically movable.

As shown in FIGS. 7 and 8, the blade receiving member 701A is located at a position facing the lower blade 703 beyond the bundle of sheets SS.

The blade receiving member 701A and the sheet supporting member 702 are made of an electrically conductive material, composed of a low frictional resin material, the details of which will be explained later.

Numerals 704 and 705 represent links whose ends are connected rotatably to the sheet holding member 701 near both ends of the sheet holding member 701 and other ends are connected rotatably to female screw units 706 and 707 respectively as shown in FIG. 7.

The female screw units 706 and 707 are engaged with a male screw rod 708 on which two male screws are threaded in the opposite directions to one another.

The male screw rod 708 is supported rotatably by main body side boards 700B and 700C of the sheet trimming apparatus 700, and the rotation is transmitted from a sheet holding motor 709 which is reversible in terms of rotation via plural gears (no reference numbers).

Accordingly, the sheet holding member 701 moves up and down owing to bidirectional rotation of the sheet holding motor 709.

The above-mentioned plural gears are arranged to transmit rotation of the sheet holding motor 709 to the male screw rod 708, and also reduce the rotation speed.

In this structure, a large torque can be generated even though the motor capacity of the sheet holding motor 709 is small, and the bundle of sheets SS is securely held by the blade receiving member 701A and the sheet supporting member 702 with a large force to avoid slipping of the sheets while the trimming process is carried out.

Two rotatable rollers 715 and 716 are installed on the lower blade 703 and the rollers 715 and 716 are engaged slidably with guide members 717 and 718 fixed on the main body of the sheet trimming apparatus 700 (no reference numbers).

Sliding portions of the guide members 717 and 718 are angled toward the upper left, as shown in FIG. 7.

The lower blade 703 has a connecting arm 703A, and a roller 719 is installed rotatably to the end of the connecting part 703A.

The roller 719 is fitted slidably into a vertical guide groove 725A which is formed on a lower blade driving member 725, as shown in FIG. 7.

Numeral 725 represents a lower blade driving member and is engaged with male screw rods 726 and 727, which are supported by the main body side boards 700B and 700D rotatably, and rotation is transmitted from a reversible lower blade driving motor 728 via plural gears (no reference numbers) so that the direction of rotation of both screws is synchronized.

The male screw rods 726 and 727 rotate in the same direction and move the lower blade driving member 725 reciprocatively in the directions of arrow Q, as shown in FIG. 7, by bidirectional rotation of the lower blade driving motor 728.

Consequently, the rollers 715 and 716 move along the sliding parts of the guide members 717 and 718, and the lower blade 703 shifts straight in the direction formed by the sliding parts, that is, the direction from the upper left to the lower right and vice versa as illustrated in FIG. 7.

Next to be explained will be operation of the sheet trimming apparatus 700 of the structure described above, the inserting operation of the bundle of sheets SS into the trimming section, and the removing operation of the bundle of sheets SS from the trimming section, referring mainly to FIG. 8.

The bundle of sheets SS, which has been center-folded and saddle-stitched, slides on the sheet loading table 602 while being securely held by the fold-holding member 605 and the backing plate 606, and travels in the direction of arrow H in FIG. 8. Then bundle of sheets SS is inserted into the trimming section comprising the blade receiving member 701A, the sheet supporting member 702 and the lower blade 703, and stops at a predetermined position according to the each sheet size.

When the bundle of sheets SS stops, the sheet holding motor 709 (refer to FIG. 7) rotates and lowers sheet holding member 701, and the area near the edge of bundle of sheets SS is securely held between the blade receiving member 701A and the sheet supporting member 702.

When the bundle of sheets SS is securely held, lower blade driving motor 728 (refer to FIG. 7) rotates and lower blade 703 rises toward the upper left in FIG. 7 while conducting press cutting of bundle of sheets SS until the edge of the blade slightly sinks into blade receiving member 701A to finish the edge trimming process of bundle of sheets SS.

After completion of the edge trimming process, the lower blade driving motor 728 reverses, and the lower blade 703 lowers obliquely toward the lower right in FIG. 7 to the initial position.

After complete lowering of the lower blade 703, the sheet holding member 701 rises to the initial position.

After complete rising of the sheet holding member 701, the fold-holding member 605 and the backing plate 606 which have securely held the vicinity of the fold of the bundle of sheets SS, return to the each initial position shown in FIG. 6(b), and the fold-holding member 605 rises and the aligning member 604 retracts below the sheet conveyance surface to release the bundle of sheets SS.

Consequently, the trimming conveyer 600 rotates and the edge-trimmed bundle of sheets SS is pushed by the stopper claw 603 and falls down from the end of the trimming conveyer 600 in the direction of the arrow as shown in FIG. 4. Then, the trimmed bundle of sheets SS is conveyed by the rotating collecting conveyer 800 and discharged into the paper discharge tray 850 located in front of the sheet post-processing apparatus B.

Next, the materials of the blade receiving member 701A and the sheet supporting member 702, which are features of this invention, will be explained.

The blade receiving member 701A and the sheet supporting member 702 have conductivity, however “conductivity” in the present invention means volume resistivity of 10¹⁰ Ω·cm or less, preferably 10⁷ Ω·cm or less and more preferably 10⁶ Ω·cm or less. Volume resistivity of 10¹⁰ Ω·cm or less, after the trimming process, allows strips to fall down into a strip receptor placed under the trimming section, without electrostatic adsorption of trimmed strips to the blade receiving member 701A or the sheet supporting member 702. Further, the desired effect increases at volume resistivity of 10⁷ Ω·cm or less, and almost all strips fall down at volume resistivity of 10⁶ Ω·cm or less, regardless of any environmental conditions and type of sheets.

In this embodiment, the blade receiving member 701A and the sheet supporting member 702 are structured of electrically conductive resin which is produced by compounding electrically conductive materials such as carbon, metal and oxidized metal into a resin such as polycarbonate, ABS, polyurethane, acrylic resin, POM and PP, the volume resistivity of which is typically 10³ Ω·cm to 10¹⁰ Ω·cm and preferably 10³ Ω·cm to 10⁷ Ω·cm.

The blade receiving member 701A and the sheet supporting member 702 can enhance static electricity elimination ability by grounding, whereby further preferable effects can be achieved. As grounding methods, any appropriate conventional ones may be employed.

Further it is preferable that the blade receiving member 701A and the sheet supporting member 702 are low friction members, for example it is possible to obtain a low friction member by molding the afore-said electrically conductive resin or by machining, and a further lower frictional material can be obtained by mat finishing the surface of the blade receiving member 701A which contacts bundle of sheets SS or the surface of the sheet supporting member 702 which also contacts the bundle of sheets SS.

Although in this embodiment, all parts of each the blade receiving member 701A and the sheet supporting member 702 are structured of an electrically conductive and low friction resin material, for example, it is possible for a sheet-shaped member made by compounding above-mentioned electrically conductive materials into resin materials such as nylon, PVC and polycarbonate to be fixed by adhesives onto the area of the blade receiving member 701A which contacts a bundle of sheets, excluding the area which the lower blade 703 comes into contact with, as well as the area of the sheet supporting member 702 which contacts the bundle of sheets. Further the sheet-shaped member can be electrically grounded, and it is also preferable to apply a mat finish to the surface of the sheet-shaped member to obtain lower friction.

As described above, by using a sheet-shaped member, it becomes possible to select materials for the blade receiving member 701A or the sheet supporting member 702 considering ease of procurement and cost reduction.

The blade receiving member 701A excluding the portion where the lower blade 703 comes into contact with the blade receiving member 701A or the sheet supporting member 702, can be structured of metal such as stainless steel or aluminum.

In this embodiment, the blade receiving member 701A and the sheet supporting member 702 are structured of electrically conductive and low friction materials. However in consideration of electrification properties of sheets to be used and humidity where the apparatus is used, either of the above-mentioned members can be structured by an electrically conductive and low frictional material. When either of the members is structured of an electrically conductive material, in the case of this embodiment, because the blade receiving member 701A is located above the bundle of sheets SS and, on the other hand, the sheet supporting member 702 is located below, employing electrically conductive material for the blade receiving member 701A which is located on the upper side, results in a more desired effect to drop trimmed strips by avoiding electrostatic adsorption on the blade receiving member 701A. However, employing electrically conductive material for the sheet supporting member 702 in addition to the blade receiving member 701A, would of course, improve the desired effects to collect strips into the strip receptor without electrostatic adsorption of falling strips onto the sheet supporting member 702.

Further, in this embodiment, members are structured to securely hold bundle of sheets between the blade receiving member 701A and the sheet supporting member 702, however it is possible to structure members so that the bundle of sheets can be securely held between the sheet supporting member and another member, instead of the blade receiving member. In that case, an electrically conductive surface may be provided on not only the blade receiving member but also on both the sheet supporting member and the other member, or either the sheet supporting member or the other member.

In this embodiment, employed is a structure of the sheet trimming apparatus in which the trimming blade rises to cut sheets, however the blade could also be lowered to cut the sheets. As explained above, by at least forming the surface of an electrically conductive material which comes into contact with a bundle of sheets on the blade receiving member or the sheet supporting member, avoided can be that trimmed strips cling to the blade receiving member or to the sheet supporting member, and do not drop because of static electricity generated during each process such as the perforating process, the stitching process or the folding process, or static electricity which is generated by rubbing action of sheets against the blade receiving member or the sheet supporting member, or static electricity generated during the trimming process.

Accordingly, eliminated are situations when trimming is carried out while strips of paper are clinging to the blade receiving member or to the sheet supporting member, therefore avoided can be pressure marks of stray strips which may have been transferred onto the bundle of sheets, resulting in deteriorated finish quality, due to the strong pressing force applied to the sheets. Further a skew or a fold of outer sheets of the bundle of sheets can also be avoided, which is typically caused by these clinging strips during the insertion of subsequent bundle of sheets.

By electrically grounding the surfaces formed of electrically conductive material, ability of static electricity elimination for a bundle of charged sheets is improved, and even if static electricity is generated from a rubbing action of sheets against the blade receiving member or the sheet supporting member, the static charge can be soon eliminated.

Further, by allowing the surface of electrically conductive material to exhibit low friction, any rubbing action of sheets on the blade receiving member or on the sheet supporting member becomes smaller and it is possible to almost totally avoid generating static charge.

What is claimed is

1. A sheet trimming apparatus to trim a bundle of sheets, comprising:
a trimming blade to trim a bundle of sheets,
a blade receiving member located in a position facing the trimming blade to receive the trimming blade and
a sheet supporting member to hold a bundle of sheets when the bundle of sheets is trimmed with the trimming blade,
wherein at least one of the blade receiving member and the sheet supporting member has an electrically conductive surface which comes into contact with a bundle of sheets.

2. The sheet trimming apparatus of claim 1,
wherein the sheet supporting member is located in a position facing the blade receiving member such that a bundle of sheets is held between the blade receiving member and the sheet supporting member.

3. The sheet trimming apparatus of claim 1,
wherein the blade receiving member has the electrically conductive surface.

4. The sheet trimming apparatus of claim 1,
wherein both of the blade receiving member and the sheet supporting member have the electrically conductive surfaces.

5. The sheet trimming apparatus of claim 1,
wherein the blade receiving member or the sheet supporting member comprises an electrically conductive resin.

6. The sheet trimming apparatus of claim 1,
wherein the blade receiving member or the sheet supporting member has an electrically conductive sheet-shaped member on a surface which comes into contact with a bundle of sheets.

7. The sheet trimming apparatus of claim 1,
wherein the electrically conductive surface is electrically grounded.

8. The sheet trimming apparatus of claim 1,
wherein volume resistivity of an electrically conductive material structuring the electrically conductive surface is 10¹⁰ Ω·cm or less.

9. The sheet trimming apparatus of claim 8,
wherein the volume resistivity is 10⁷ Ω·cm or less.

10. A sheet post-processing apparatus comprising a sheet trimming apparatus to trim a bundle of sheets,
wherein the sheet trimming apparatus comprises,
a trimming blade to trim a bundle of sheets,
a blade receiving member located in a position facing the trimming blade to receive the trimming blade and
a sheet supporting member to hold a bundle of sheets when the bundle of sheets is trimmed with the trimming blade,
wherein at least one of the blade receiving member and the sheet supporting member has an electrically conductive surface which comes into contact with a bundle of sheets.

11. The sheet post-processing apparatus of claim 10,
wherein the blade receiving member has the electrically conductive surface.

12. The sheet post-processing apparatus of claim 10,
wherein volume resistivity of an electrically conductive material structuring the electrically conductive surface is 10¹⁰ Ω·cm or less.

13. The sheet post-processing apparatus of claim 12,
wherein the volume resistivity is 10⁷ Ω·cm or less.

14. An image forming system, comprising:
an image forming apparatus to form an image on a sheet and
a sheet post-processing apparatus to apply post-processing to the sheet on which the image is formed by the image forming apparatus,
wherein the sheet post-processing apparatus includes a sheet trimming apparatus, comprising:
a trimming blade to trim a bundle of sheets,
a blade receiving member located in a position facing the trimming blade to receive the trimming blade and
a sheet supporting member to hold a bundle of sheets when the bundle of sheets is trimmed with the trimming blade,
wherein at least one of the blade receiving member and the sheet supporting member has an electrically conductive surface which comes into contact with a bundle of sheets.

15. The image forming system of claim 14,
wherein the blade receiving member has the electrically conductive surface.

16. The image forming system of claim 14,
wherein volume resistivity of an electrically conductive material structuring the electrically conductive surface is 10¹⁰ Ω·cm or less.

17. The image forming system of claim 16,
wherein the volume resistivity is 10⁷ Ω·cm or less.
